(19) United States
(12) Patent Application Publication
(10) Pub. No.: US 2026/0292606 A1
(43) Pub. Date: Sep. 24, 2026

(54) METHODS AND CENTRAL UNITS OF WIRELESS COMMUNICATIONS NETWORKS

(71) Applicant: Sony Group Corporation, Tokyo (JP)

(72) Inventors: Vivek SHARMA, Basingstoke (GB); Yassin Aden AWAD, Basingstoke (GB); Yuxin WEI, Basingstoke (GB)

(73) Assignee: Sony Group Corporation, Tokyo (JP)

(21) Appl. No.: 19/490,965

(22) PCT Filed: Jul. 3, 2024
(86) PCT No.: PCT/EP2024/068776

§ 371 Date: Dec. 8, 2025

(30) Foreign Application Priority Data
Jul. 10, 2023 (EP) 23184426.7

(51) Int. Cl. H04W 36/00; H04W 12/04

(52) U.S. Cl. CPC H04W 36/0038; H04W 12/04

(57) ABSTRACT

A method of operating a source central unit (CU) of a wireless communications network is provided. The method includes communicating signals with a communications device operating in a connected state with the source CU, determining that the device is to hand over to a target CU, and performing a handover procedure with the device and the target CU. The handover procedure uses signalling only at a physical layer and/or a data link layer at the source CU, the target CU, and the device. The method further includes controlling, for a specified time period following the handover procedure, a target distributed unit (DU) associated with the target CU.

### BACKGROUND

### Field of Disclosure

The present disclosure relates to source and target central units of wireless communications networks and methods of operating such source and target central units for the more efficient handling of mobility procedures in such wireless communications networks.

The present application claims the Paris Convention priority from European patent application number EP23184426.7, filed on 10 Jul. 2023, the contents of which are hereby incorporated by reference.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Previous generation mobile telecommunication systems, such as those based on the 3GPP defined UMTS and Long Term Evolution (LTE) architecture, are able to support a wider range of services than simple voice and messaging services offered by previous generations of mobile telecommunication systems. For example, with the improved radio interface and enhanced data rates provided by LTE systems, a user is able to enjoy high data rate applications such as mobile video streaming and mobile video conferencing that would previously only have been available via a fixed line data connection. The demand to deploy such networks is therefore strong and the coverage area of these networks, i.e. geographic locations where access to the networks is possible, is expected to continue to increase rapidly.

Current and future wireless communications networks are expected to routinely and efficiently support communications with an ever-increasing range of devices associated with a wider range of data traffic profiles and types than existing systems are optimised to support. For example, it is expected future wireless communications networks will be expected to efficiently support communications with devices including reduced complexity devices, machine type communication (MTC) devices, high resolution video displays, virtual reality headsets, extended Reality (XR) and so on. Some of these different types of devices may be deployed in very large numbers, for example low complexity devices for supporting the “The Internet of Things”, and may typically be associated with the transmissions of relatively small amounts of data with relatively high latency tolerance. Other types of device, for example supporting high-definition video streaming, may be associated with transmissions of relatively large amounts of data with relatively low latency tolerance. Other types of device, for example used for autonomous vehicle communications and for other critical applications, may be characterised by data that should be transmitted through the network with low latency and high reliability. A single device type might also be associated with different traffic profiles/characteristics depending on the application(s) it is running. For example, different consideration may apply for efficiently supporting data exchange with a smartphone when it is running a video streaming application (high downlink data) as compared to when it is running an Internet browsing application (sporadic uplink and downlink data) or being used for voice communications by an emergency responder in an emergency scenario (data subject to stringent reliability and latency requirements).

In view of this there is expected to be a desire for current wireless communications networks, for example those which may be referred to as 5G or new radio (NR) systems/new radio access technology (RAT) systems, or indeed future 6G wireless communications, as well as future iterations/releases of existing systems, to efficiently support connectivity for a wide range of devices associated with different applications and different characteristic data traffic profiles and requirements. The desire to support these new use-cases and scenarios gives rise to new challenges for efficiently handling communications in wireless communications systems that need to be addressed.

### SUMMARY OF THE DISCLOSURE

The present disclosure can help address or mitigate at least some of the issues discussed above.

Some embodiments of the present technique can provide a method of operating a source central unit, CU, of a wireless communications network. The method comprises transmitting signals to and/or receiving signals from a communications device which is operating in a connected state with the source CU, determining that the communications device is to hand over from the source CU to a target CU of the wireless communications network, performing, with the communications device and the target CU, a handover procedure to hand the communications device over from the source CU to the target CU, wherein the handover procedure consists of signalling only at a physical layer at each of the source CU, the target CU, and the communications device and/or a data link layer at each of the source CU, the target CU, and the communications device, and controlling, for a specified time period following the handover procedure, a target distributed unit, DU, associated with the target CU.

Such embodiments of the present technique, which, in addition to methods of operating source CUs, relate to methods of operating target CUs, to source CUs and target CUs, to circuitry for source CUs and target CUs, wireless communications systems, computer programs, and computer-readable storage mediums, can allow for the more efficient handling of mobility procedures in such wireless communications networks.

Respective aspects and features of the present disclosure are defined in the appended claims.

It is to be understood that both the foregoing general description and the following detailed description are exemplary, but are not restrictive, of the present technology. The described embodiments, together with further advantages, will be best understood by reference to the following detailed description taken in conjunction with the accompanying drawings.

### BRIEF DESCRIPTION OF THE DRAWINGS

A more complete appreciation of the disclosure and many of the attendant advantages thereof will be readily obtained as the same becomes better understood by reference to the following detailed description when considered in connection with the accompanying drawings wherein like reference numerals designate identical or corresponding parts throughout the several views, and wherein:

FIG. 1 schematically represents some aspects of an LTE-type wireless telecommunication system which may be configured to operate in accordance with certain embodiments of the present disclosure;

FIG. 2 schematically represents some aspects of an NR-type wireless telecommunications system which may be configured to operate in accordance with certain embodiments of the present disclosure;

FIG. 3 is a schematic block diagram of an example infrastructure equipment and communications device which may be configured to operate in accordance with certain embodiments of the present disclosure;

FIG. 4A is a representation of a gNB distributed unit (DU) and a gNB controlling unit (CU) communicating via an F1 interface;

FIG. 4B is a schematic representation of a protocol stack operated respectively by the gNB DU and gNB CU shown in FIG. 4A for communicating control plane data;

FIG. 4C is a schematic representation of a protocol stack operated respectively by the gNB DU and gNB CU shown in FIG. 4A for communicating user plane data;

FIG. 5 schematically illustrates a split of gNB functionality between a CU-CP, CU-UP and the DU according to current architecture;

FIG. 6 illustrates the scope of Layer 1/Layer 2 Triggered Mobility (LTM) in current 3GPP specifications;

FIG. 7 is reproduced from [9], and shows an example message sequence for LTM in accordance with current 3GPP specifications;

FIG. 8 shows an example message sequence for inter-CU LTM, in accordance with which embodiments of the present technique may be configured to operate;

FIG. 9 shows a part schematic, part message flow diagram representation of a wireless communications system comprising a communications device and an infrastructure equipment in accordance with embodiments of the present technique;

FIG. 10 illustrates an example of CU-DU connectivity for inter-CU LTM in accordance with embodiments of the present technique; and

FIG. 11 shows a flow diagram illustrating an example process of communications in a communications system in accordance with embodiments of the present technique.

### DETAILED DESCRIPTION OF THE EMBODIMENTS

### Long Term Evolution Advanced Radio Access Technology (4G)

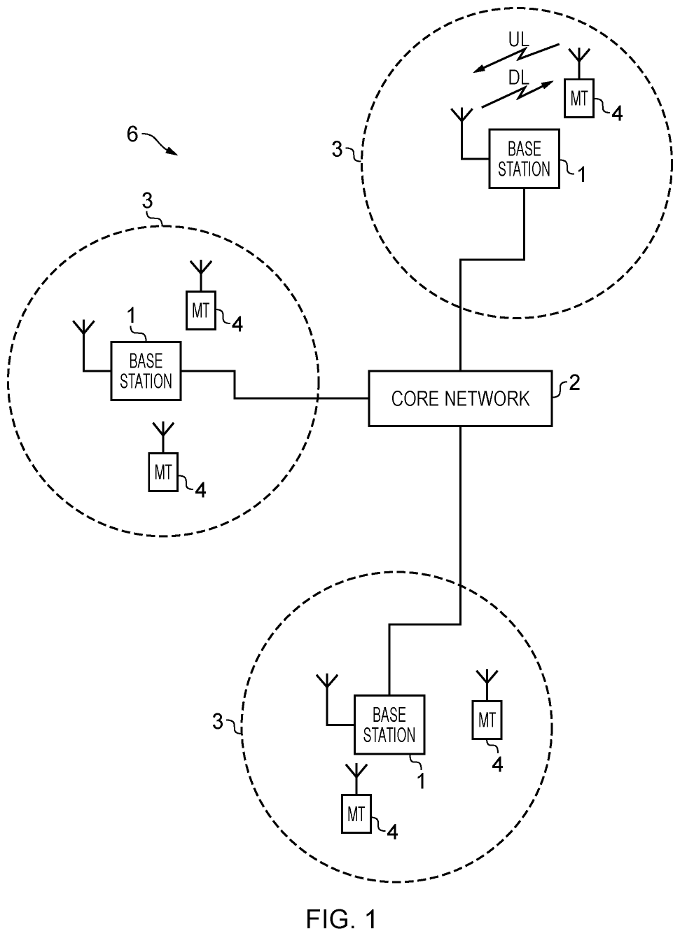

FIG. 1 provides a schematic diagram illustrating some basic functionality of a mobile telecommunications network/system 6 operating generally in accordance with LTE principles, but which may also support other radio access technologies, and which may be adapted to implement embodiments of the disclosure as described herein. Various elements of FIG. 1 and certain aspects of their respective modes of operation are well-known and defined in the relevant standards administered by the 3GPP (RTM) body, and also described in many books on the subject, for example, Holma H. and Toskala A [1]. It will be appreciated that operational aspects of the telecommunications networks discussed herein which are not specifically described (for example in relation to specific communication protocols and physical channels for communicating between different elements) may be implemented in accordance with any known techniques, for example according to the relevant standards and known proposed modifications and additions to the relevant standards.

The network 6 includes a plurality of base stations 1 connected to a core network 2, which may be for example an Evolved Packet Core (EPC). Each base station provides a coverage area 3 (i.e., a cell) within which data can be communicated to and from communications devices 4. Although each base station 1 is shown in FIG. 1 as a single entity, the skilled person will appreciate that some of the functions of the base station may be carried out by disparate, inter-connected elements, such as antennas (or antennae), remote radio heads, amplifiers, etc. Collectively, one or more base stations may form a radio access network.

Data is transmitted from base stations 1 to communications devices 4 within their respective coverage areas 3 via a radio downlink (DL). Data is transmitted from communications devices 4 to the base stations 1 via a radio uplink (UL). The core network 2 routes data to and from the communications devices 4 via the respective base stations 1 and provides functions such as authentication, mobility management, charging and so on. Terminal devices may also be referred to as mobile stations, user equipment (UE), user terminal, mobile radio, communications device, and so forth. Services provided by the core network 2 may include connectivity to the internet or to external telephony services. The core network 2 may further track the location of the communications devices 4 so that it can efficiently contact (i.e., page) the communications devices 4 for transmitting downlink data towards the communications devices 4.

Base stations, which are an example of network infrastructure equipment, may also be referred to as transceiver stations, nodeBs, e-nodeBs, eNB, g-nodeBs, gNB and so forth. In this regard different terminology is often associated with different generations of wireless telecommunications systems for elements providing broadly comparable functionality. However, certain embodiments of the disclosure may be equally implemented in different generations of wireless telecommunications systems, and for simplicity certain terminology may be used regardless of the underlying network architecture. That is to say, the use of a specific term in relation to certain example implementations is not intended to indicate these implementations are limited to a certain generation of network that may be most associated with that particular terminology.

### New Radio Access Technology (5G)

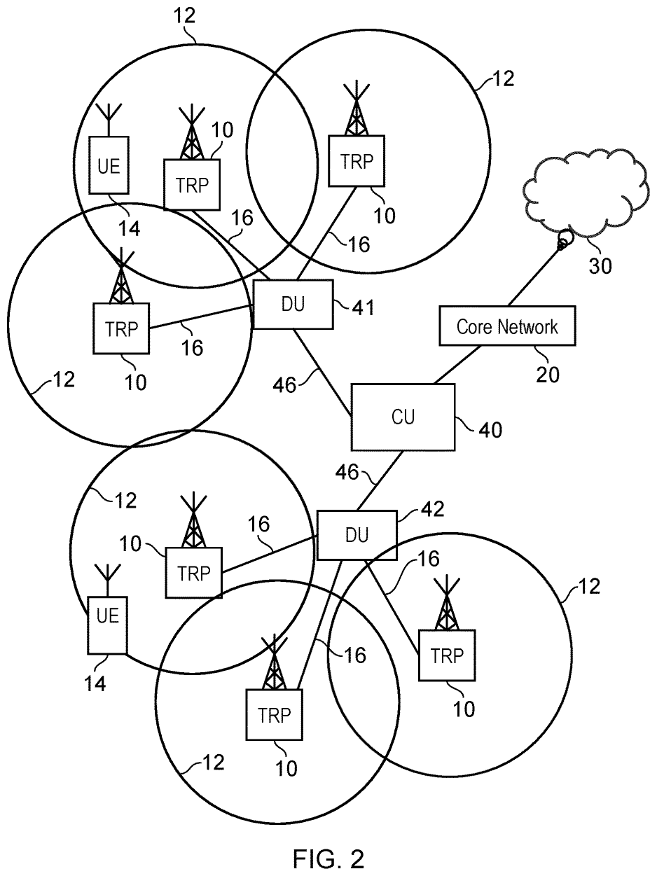

An example configuration of a wireless communications network which uses some of the terminology proposed for and used in NR and 5G is shown in FIG. 2. In FIG. 2 a plurality of transmission and reception points (TRPs) 10 are connected to distributed control units (DUs) 41, 42 by a connection interface represented as a line 16. Each of the TRPs 10 is arranged to transmit and receive signals via a wireless access interface within a radio frequency bandwidth available to the wireless communications network. Thus, within a range for performing radio communications via the wireless access interface, each of the TRPs 10, forms a cell of the wireless communications network as represented by a circle 12. As such, wireless communications devices 14 which are within a radio communications range provided by the cells 12 can transmit and receive signals to and from the TRPs 10 via the wireless access interface. Each of the distributed units 41, 42 are connected to a central unit (CU) 40 (which may be referred to as a controlling node) via an interface 46. The central unit 40 is then connected to the core network 20 (which may be for example referred to as 5GC) which may contain all other functions required to transmit data for communicating to and from the wireless communications devices and the core network 20 may be connected to other networks 30.

The elements of the wireless access network shown in FIG. 2 may operate in a similar way to corresponding elements of an LTE network as described with regard to the example of FIG. 1. It will be appreciated that operational aspects of the telecommunications network represented in FIG. 2, and of other networks discussed herein in accordance with embodiments of the disclosure, which are not specifically described (for example in relation to specific communication protocols and physical channels for communicating between different elements) may be implemented in accordance with any known techniques, for example according to currently used approaches for implementing such operational aspects of wireless telecommunications systems, e.g. in accordance with the relevant standards.

The TRPs 10 of FIG. 2 may in part have a corresponding functionality to a base station or eNodeB of an LTE network. Similarly, the communications devices 14 may have a functionality corresponding to the UE devices 4 known for operation with an LTE network. It will be appreciated therefore that operational aspects of a new RAT network (for example in relation to specific communication protocols and physical channels for communicating between different elements) may be different to those known from LTE or other known mobile telecommunications standards. However, it will also be appreciated that each of the core network component, base stations and communications devices of a new RAT network will be functionally similar to, respectively, the core network component, base stations and communications devices of an LTE wireless communications network.

In terms of broad top-level functionality, the core network 20 connected to the new RAT telecommunications system represented in FIG. 2 may be broadly considered to correspond with the core network 2 represented in FIG. 1, and the respective central units 40 and their associated distributed units/TRPs 10 may be broadly considered to provide functionality corresponding to the base stations 1 of FIG. 1. The term network infrastructure equipment/access node may be used to encompass these elements and more conventional base station type elements of wireless telecommunications systems. Depending on the application at hand the responsibility for scheduling transmissions which are scheduled on the radio interface between the respective distributed units and the communications devices may lie with the controlling node/central unit and/or the distributed units/TRPs. A communications device 14 is represented in FIG. 2 within the coverage area of the first communication cell 12. This communications device 14 may thus exchange signalling with the first central unit 40 in the first communication cell 12 via one of the distributed units/TRPs 10 associated with the first communication cell 12.

It will further be appreciated that FIG. 2 represents merely one example of a proposed architecture for a new RAT based telecommunications system in which approaches in accordance with the principles described herein may be adopted, and the functionality disclosed herein may also be applied in respect of wireless telecommunications systems having different architectures.

Thus, certain embodiments of the disclosure as discussed herein may be implemented in wireless telecommunication systems/networks according to various different architectures, such as the example architectures shown in FIGS. 1 and 2. It will thus be appreciated the specific wireless telecommunications architecture in any given implementation is not of primary significance to the principles described herein. In this regard, certain embodiments of the disclosure may be described generally in the context of communications between network infrastructure equipment/access nodes and a communications device, wherein the specific nature of the network infrastructure equipment/access node and the communications device will depend on the network infrastructure for the implementation at hand. For example, in some scenarios the network infrastructure equipment/access node may comprise a base station, such as an LTE-type base station 1 as shown in FIG. 1 which is adapted to provide functionality in accordance with the principles described herein, and in other examples the network infrastructure equipment may comprise a control unit/controlling node 40 and/or a TRP 10 of the kind shown in FIG. 2 which is adapted to provide functionality in accordance with the principles described herein.

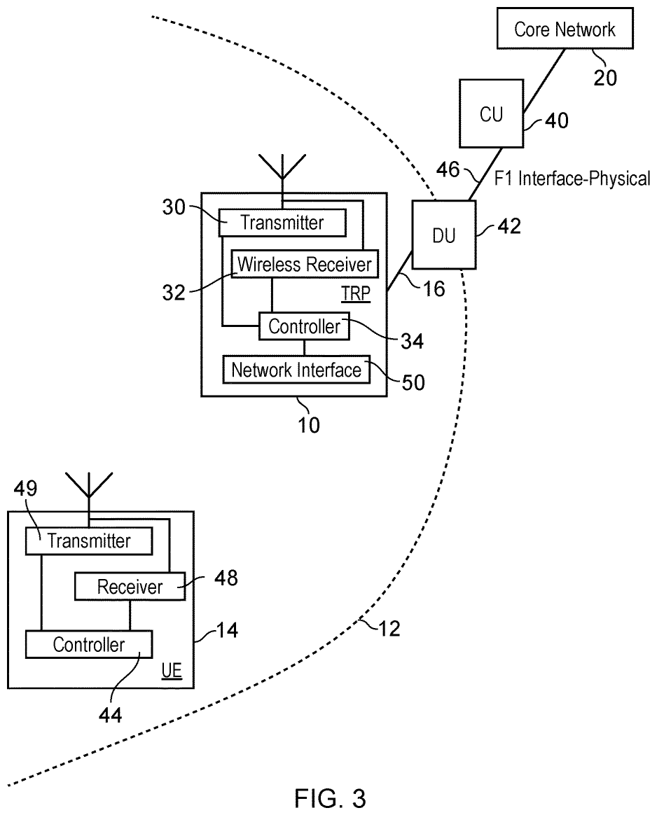

A more detailed diagram of some of the components of the network shown in FIG. 2 is provided by FIG. 3. In FIG. 3, a TRP 10 as shown in FIG. 2 comprises, as a simplified representation, a wireless transmitter 30, a wireless receiver 32 and a controller or controlling processor 34 which may operate to control the transmitter 30 and the wireless receiver 32 to transmit and receive radio signals to one or more UEs 14 within a cell 12 formed by the TRP 10. As shown in FIG. 3, an example UE 14 is shown to include a corresponding transmitter 49, a receiver 48 and a controller 44 which is configured to control the transmitter 49 and the receiver 48 to transmit signals representing uplink data to the wireless communications network via the wireless access interface formed by the TRP 10 and to receive downlink data as signals transmitted by the transmitter 30 and received by the receiver 48 in accordance with the conventional operation.

The transmitters 30, 49 and the receivers 32, 48 (as well as other transmitters, receivers and transceivers described in relation to examples and embodiments of the present disclosure) may include radio frequency filters and amplifiers as well as signal processing components and devices in order to transmit and receive radio signals in accordance for example with the 5G/NR standard. The controllers 34, 44 (as well as other controllers described in relation to examples and embodiments of the present disclosure) may be, for example, a microprocessor, a CPU, or a dedicated chipset, etc., configured to carry out instructions which are stored on a computer readable medium, such as a non-volatile memory. The processing steps described herein may be carried out by, for example, a microprocessor in conjunction with a random access memory, operating according to instructions stored on a computer readable medium. The transmitters, the receivers and the controllers are schematically shown in FIG. 3 as separate elements for ease of representation. However, it will be appreciated that the functionality of these elements can be provided in various different ways, for example using one or more suitably programmed programmable computer(s), or one or more suitably configured application-specific integrated circuit(s)/ circuitry/chip(s) / chipset(s). As will be appreciated the infrastructure equipment/TRP/base station as well as the UE/communications device will in general comprise various other elements associated with its operating functionality.

As shown in FIG. 3, the TRP 10 also includes a network interface 50 which connects to the DU 42 via a physical interface 16. The network interface 50 therefore provides a communication link for data and signalling traffic from the TRP 10 via the DU 42 and the CU 40 to the core network 20.

The interface 46 between the DU 42 and the CU 40 is known as the F1 interface which can be a physical or a logical interface. The F1 interface 46 between CU and DU may operate in accordance with 3GPP technical specifications [2] and [3], and may be formed from a fibre optic or other wired or wireless high bandwidth connection. In one example the connection 16 from the TRP 10 to the DU 42 is via fibre optic. The connection between a TRP 10 and the core network 20 can be generally referred to as a backhaul, which comprises the interface 16 from the network interface 50 of the TRP 10 to the DU 42 and the F1 interface 46 from the DU 42 to the CU 40.

As will be appreciated by those acquainted with 5G architecture, the CU 40 may be a logical node which hosts Radio Resource Control (RRC) protocols, Service Data Adaptation Protocols (SDAP), and Packet Data Convergence Protocols (PDCP) of a gNB. Alternatively, the CU 40 may be a logical node which hosts RRC and PDCP protocols of an en-gNB (which is a gNB that is able to connect with both EPC and eNBs and can be understood as being, for example, a secondary node (SgNB) used in dual connectivity scenarios). The CU 40 partly controls the operation of one or more DUs 40 and terminates the F1 interface 46 for the DUs that it controls. The DU 42 may be a logical node which hosts Radio Link Control (RLC), Medium Access Control (MAC), and Physical (PHY) layers of a gNB or en-gNB. The operation of the DU 42 is partly controlled by the CU 40 for which the DU 42 terminates the F1 interface 46.

Although not shown in FIG. 2 or 3, it will be familiar to those acquainted with 5G architecture that the CU 40 may be further split into a CU-CP which performs the control plane functions of the CU 40 and a CU-UP which performs the user plane functions of the CU 40 (see for example, [4]). In more detail, the CU-CP may be a logical node hosting an RRC protocol and a control plane part of a PDCP protocol of the CU 40 for the gNB or en-gNB. The CU-CP terminates an E1 interface connected with the CU-UP and an F1-C interface connected with the DU 42. As will be appreciated, the F1-C interface carries control plane signalling of the F1 interface 46. The CU-UP may be a logical node which hosts a user plane part of a PDCP protocol of the CU 40 for an en-gNB. Alternatively, the CU-UP may be a logical node which hosts a user plane part of the PDCP protocol and an SDAP protocol of the CU 40 for a gNB. The CU-UP terminates an E1 interface connected with the CU-CP and an F1-U interface connected with the DU 42. As will be appreciated, the F1-U interface carries user plane signalling of the F1 interface 46.

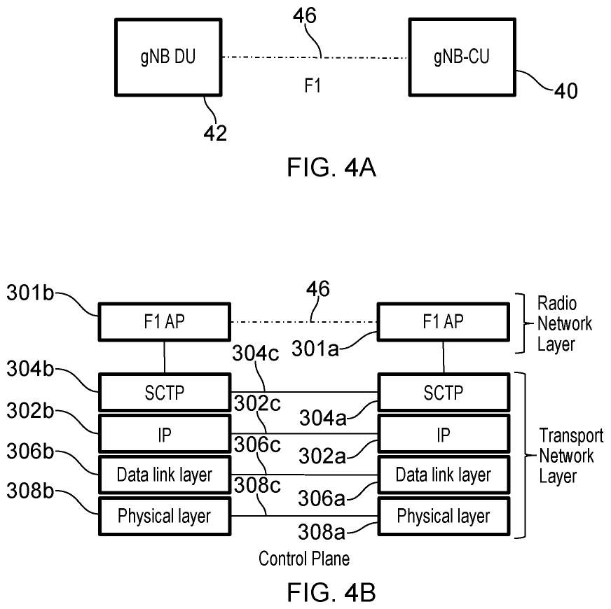

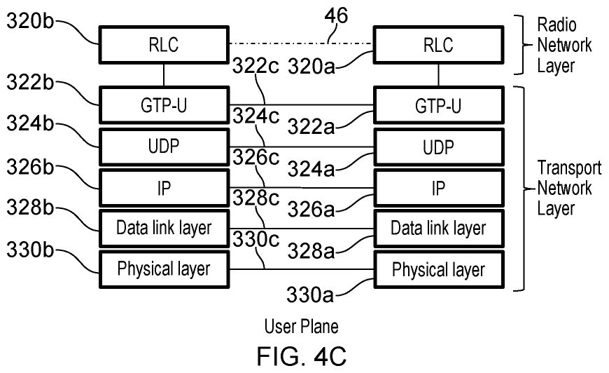

In order to appreciate example embodiments, a protocol stack for forming a conventional F1 interface shown in FIGS. 2 and 3 will be explained with reference to FIGS. 4A, 4B, and 4C. In respect of a protocol stack, FIGS. 4A, 4B, and 4C provide an illustration of processing performed by the elements shown in FIGS. 2 and 3 which form the packet data communications path 46 between the gNB-DU 42 and the gNB-CU 40 via the F1 interface 46. Control plane communications are considered separately to user plane data, although in practice they form the same interface and are processed and transmitted by the same hardware equipment.

As shown in FIG. 4A, communication is formed between the gNB DU 42 and a gNB CU 40 for the F1 interface 46. However, the control plane protocol stack to form this interface is shown in FIG. 4B, and the user plane protocol stack for communicating the user data between the gNB-CU 40 and gNB-DU 42 is shown in FIG. 4C. As shown in FIG. 4B, at the radio network layer, the control plane is formed by F1 Application Protocols (F1APs) 301a in the gNB-CU 40 and by F1 APs 301b in the gNB DU 42. As will be understood by those acquainted with the 5G Architecture, communication between a gNB-CU and a gNB DU is by IPv6 or IPv4 Internet protocols as specified in [5]. This is shown in FIG. 4B as an IP layer 302a in the gNB-CU 40 and an IP layer 302b in the gNB-DU 42, forming an IP communication interface 302c. A Stream Control Transmission Protocol (SCTP) layer of the protocol stack 304a, 304b, 304c controls end to end communication via the IP layer 302 including flow control and quality of service. The IP data is communicated between the gNB DU and gNB CU via logical data link layer 306a, 306b, 306c and the physical layer 308a, 308b, 308c.

In the user plane, the radio network layer is formed by RLC layer 320a, 320b to form the F1 interface for communicating use plane data 46. The protocol stack in the transport layer comprises a General Packet Ratio Service (GPRS) Tunnelling Protocol for user plane data (GTP-U) 322a, 322b, 322c, which controls communication of user plane data for roaming and home subscribers via a UDP layer 324a, 324b, 324c which controls communication of user plane data via an IP layer 326a, 326b, 326c. As with the control plane, the IP data is communicated between the gNB DU and gNB CU via logical data link layer 328a, 328b, 328c and the physical layer 330a, 330b, 330c.

### CU-DU Split Functions

As indicated above, the CU 40 and DU 42 are configured to execute gNB functionality. The allocation or splitting of gNB functions between the CU 40 and the DU 42 is discussed in [6]. Such gNB functions include:
Functions for Radio Resource Management: Radio Bearer Control, Radio Admission Control, Connection Mobility Control, Dynamic allocation of resources to UEs in both uplink and downlink (scheduling);
IP and Ethernet header compression, encryption and integrity protection of data;
Selection of an Access and Mobility Management Function (AMF) at UE attachment when no routing to an AMF can be determined from the information provided by the UE;
Routing of User Plane data towards User Plane Functions (UPFs);
Routing of Control Plane information towards AMF;
Connection setup and release;
Scheduling and transmission of paging messages;
Scheduling and transmission of system broadcast information (originated from the AMF or OAM);
Measurement and measurement reporting configuration for mobility and scheduling;
Transport level packet marking in the uplink;
Session Management;
Support of Network Slicing;
QoS Flow management and mapping to data radio bearers;
Support of UEs in RRC_INACTIVE state;
Distribution function for NAS messages;
Radio access network sharing;
Dual Connectivity;
Tight interworking between NR and E-UTRA; and
Maintain security and radio configuration for User Plane Cellular Internet of Things (CIOT) 5GS Optimisation, as defined in [7] (ng-eNB only).

All functions listed above, except for the final function, can be performed by gNBs and ng-eNBs while the final function relating to the maintenance of security and radio configurations is performed by ng-eNBs only. As those skilled in the art would understand, an ng-eNB is an eNB which connects 5G UEs to the 5G core network using 4G LTE air interface. Furthermore, bandwidth reduced low complexity (BL) UEs or UEs in enhanced coverage are only supported by ng-eNBs (see, for example, [8]). Additionally, NB-IOT UE is only supported by ng-eNBs (see, for example, [8]).

As will be appreciated, 5G networks are currently deployed in millimetre wave band. However, due to the higher communication bandwidths that can be achieved at higher frequencies, there is an increased demand for wireless communications at higher frequencies in 5G networks. The use of higher frequencies in wireless communications leads to increased path loss and therefore smaller cell sizes than if lower frequencies were used. As a result, in order to achieve suitable coverage, a dense deployment of networks may be required.

A dense deployment of networks creates a number of technical challenges for the current 5G architecture as explained with reference to FIGS. 2 and 3. For example, as mentioned previously, the DU 42 and the CU 40 may be connected over a wired connection 46 such as fibre optic. Therefore, a dense deployment of networks may increase the number of required wired connections which may not always be possible. Furthermore, the use of wired connections 46 between the CU 40 and the DU may lead to increased latency due to current topology designs. For example, as will be appreciated from FIG. 2, two DUs 41, 42 are connected to the CU 40 via wired connections 46 in a “tree topology”. Therefore, if any direct signalling is required between two cells 12 (for example, one cell provided by DU 41 and one cell provided by DU 42) then such signalling must propagate via the CU 40. This can lead to congestion and increased latency, especially when a large number of cells are deployed in close proximity, such as in dense deployment scenarios.

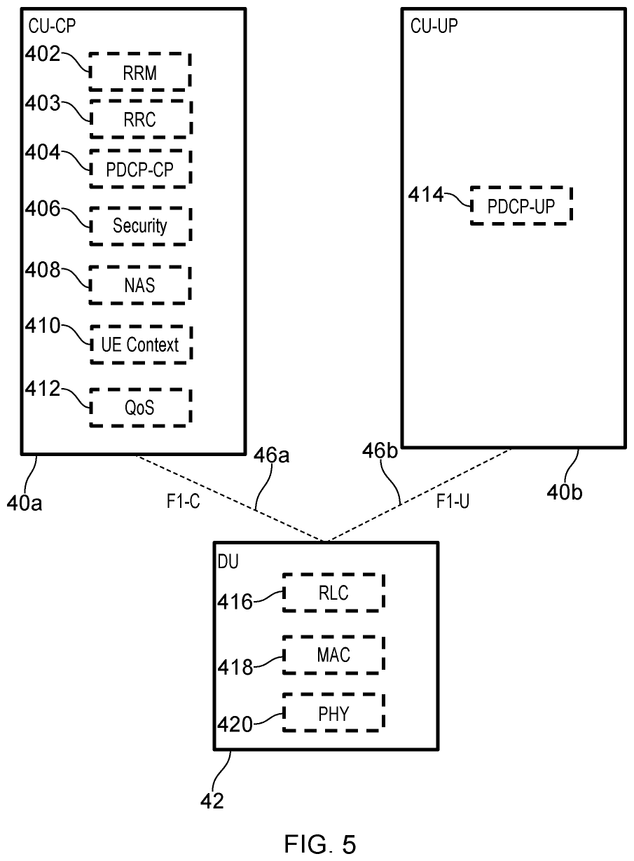

Furthermore, as will be explained in more detail with reference to FIG. 5, a higher cell density creates technical challenges in providing cell mobility and interference management. FIG. 5 illustrates a split of gNB functionality between a CU-CP 40a, CU-UP 40b and the DU 42 according to current 5G architectures. The CU-CP 40a and CU-UP 40b are logical nodes which perform the functions of the CU 40 described with reference to FIGS. 2, 3, and 4. As shown in FIG. 5, the CU-CP 40a is configured to perform radio resource management (RRM) functions 402, Radio Resource Control (RRC) functions 403, Packet Data Convergence Protocol Control Plane (PDCP-CP) functions 404, Security functions 406, Non-Access Stratum (NAS) functions 408, user equipment (UE) context functions 410, and Quality of Service (QOS) functions 412. The CU-UP 40b is configured to perform Packet Data Convergent Protocol User Plane (PDCP-UP) functions 414. The DU 42 is configured to perform RLC functions 416, MAC functions 418, PHY functions 420. As will be appreciated, a scheduler in the DU 42 may be implemented based on the guidelines as mentioned in section 10 of [6].

### Layer 1/Layer 2 Triggered Mobility (LTM)

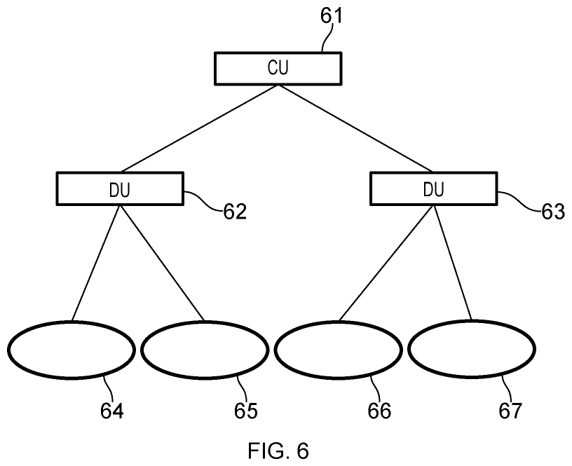

Release 18 of the 3GPP standards specified intra-CU-both intra-DU and inter-DU-L1/2 Triggered Mobility (LTM). LTM may alternatively stand for “Lower-layer Triggered Mobility”. The operation of LTM itself will be described in more detail in the paragraphs below, but in simplistic terms, as would be well understood by those skilled in the art, LTM refers to UE mobility which is controlled entirely by layer 1 (i.e. the physical layer) and layer 2 (i.e. the data link layer) of the 5G protocol stack. Both intra-DU and inter-DU LTM (both intra-CU) can be understood with reference to FIG. 6. As can be seen in the example of FIG. 6, two DUs 62, 63 are connected to a single CU 61. Each DU 62, 63 supports two cells, with DU 62 supporting cells 64 and 65, and DU 63 supporting cells 66 and 67. In intra-CU LTM a UE is handed over between a source and target cell which are both under control (via the same or separate DUs) of the same CU, such as CU 61 of FIG. 6. For intra-DU LTM, handover may be triggered and controlled by layers 1 and 2 for a UE between cells 64 and 65 (controlled by the same DU 62) or cells 66 and 67 (controlled by the same DU 63). For inter-DU LTM, handover may be triggered and controlled by layers 1 and 2 for a UE between one of cells 64 and 65 (controlled by DU 62) and one of cells 66 and 67 (controlled by DU 63)—e.g., inter-DU LTM may involve the UE handing over from cell 67 to cell 64. Inter-CU LTM is not yet specified in the 3GPP standards at the priority date of the present disclosure, but is expected to be specified in Release 19 of the 3GPP standards.

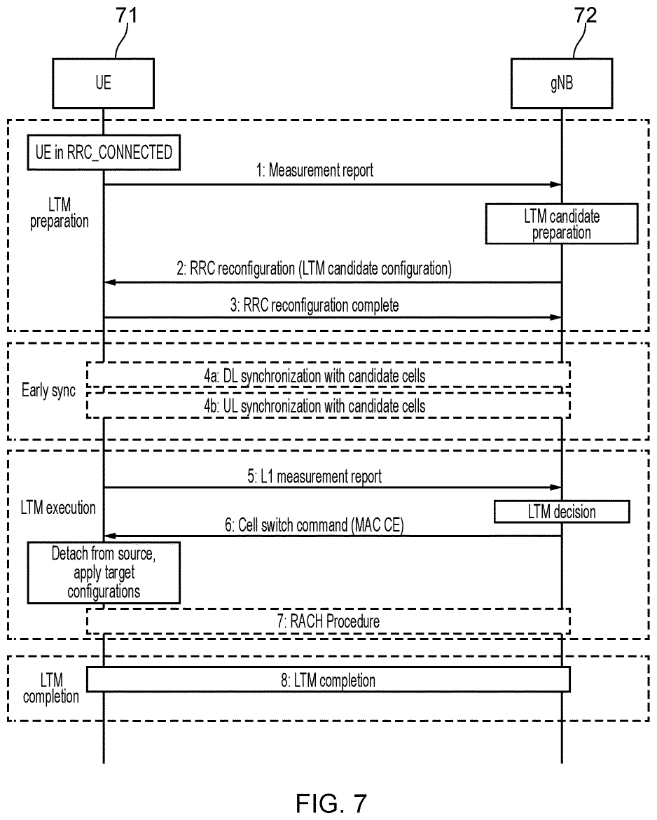

A proposed message sequence for LTM is as shown in FIG. 7, which is reproduced in [9]. The detailed procedure for LTM, as shown in FIG. 7, is described in [9], and such description is reproduced from [9] in the paragraph below for the purposes of better understanding of LTM.

In step 1, the UE 71 (while in RRC_CONNECTED mode) sends a MeasurementReport message to the gNB 72. The gNB 72 decides to use LTM and initiates candidate cell(s) preparation. In step 2, the gNB 72 transmits an RRCReconfiguration message to the UE 71 including the LTM candidate cell configurations of one or multiple candidate cells. In step 3, the UE 71 stores the LTM candidate cell configurations and transmits a RRCReconfigurationComplete message to the gNB 72. In step 4a, the UE 71 may perform DL synchronisation with candidate cell(s) before receiving the cell switch command, and in step 4b, the UE 71 may perform early timing advance (TA) acquisition with candidate cell(s) before receiving the cell switch command. This is done via Contention Free Random Access (CFRA) triggered by a Physical Downlink Control Channel (PDCCH) order from the source cell, following which the UE 71 sends a preamble towards a candidate cell. The information that identifies the allocated CFRA resource can be indicated in the PDCCH order to enable shared preamble resource among multiple UEs 71. In order to minimize the data interruption of the source cell due to CFRA towards the candidate cell(s), the UE 71 either receives a Random Access Response (RAR) from the source cell instead of the candidate cell or doesn't receive a RAR at all. Whether a RAR needs to be received is configured by the network and specific per each candidate cell. If RAR is not needed, the TA value of the candidate cell is indicated in the cell switch command. In step 5, the UE 71 performs LI measurements on the configured candidate cell(s), and transmits lower-layer measurement reports to the gNB 72. Then, in step 6, the gNB 72 decides to execute cell switch to a target cell, and transmits a MAC control element (CE) triggering cell switch by including the candidate configuration index of the target cell. The UE 71 switches to the configuration of the target cell. In step 7, the UE 71 performs a random-access procedure towards the target cell, if the cell switch needs to include the performance of such a random-access procedure. Finally, in step 8, the UE 71 completes the LTM cell switch procedure by sending RRCReconfigurationComplete message to target cell. For RACH-based LTM, the UE 71 considers that LTM execution procedure is successfully completed when the random-access procedure itself is successfully completed. For RACH-less LTM, the UE 71 considers that LTM execution procedure is successfully completed when the UE 71 determines that the network has successfully received its first UL data. The UE 71 can perform steps 4 to 8 as shown in FIG. 7 multiple times for subsequent LTM cell switch based on the configuration provided in step 2.

Some observations on LTM are provided in [10]. Specifically, it is noted in [10] that the number of handover attempts of LTM is 20 times higher than that of legacy handover if the time-to-trigger (TTT) is set to a typical value, e.g., 160 ms with 2 dB A3 -offset. The data loss rate of LTM reaches 3.9% without applying filtering. However, the data loss rate is still high at 1.7% even if filtering is applied. There is no data loss issue for RLC acknowledged mode (AM) bearers, but hybrid automatic repeat request (HARQ) reset at LTM cell switch will result in frequent ARQ retransmissions and relatively long packet delay for those packets which are subject to ARQ retransmission. For RLC AM bearers, if HARQ buffers are flushed at each LTM cell switch, the lost RLC service data units (SDUs) or RLC segments can be recovered through ARQ retransmission. Therefore, PDCP data recovery procedures are required to avoid data loss due to inter-DU LTM cell switch. At the network side, the PDCP data recovery procedures may be similar to layer 3 handover without PDCP re-establishment, or secondary node (SN) release/addition for split bearers. Therefore, the high data loss rate (1.7% or 3.9%) due to HARQ reset at LTM cell switch can't meet the QoS requirements for those services.

Thus, it would be understood by the skilled in the art that, while LTM techniques reduce latency as compared to conventional higher-layer handover techniques (because such higher layers do not need to be involved), the rate of handover itself, as well as the rate of ping-pongs and data loss, are increased. Here, a “ping-pong” can effectively be understood as a handover of a UE between a source and target cell which is then quickly handed back to the source cell. The increase in the rate of such ping-pongs is effectively because the triggers for handover at L1/L2 are more sensitive, and there are not the same well-defined events at these layers as there are at L3 (which are well defined, but may delay handover). Also, there is measurement filtering performed at L3 in L3 handover procedures, whereas L1/L2 triggers are generally based on one-shot measurements, which therefore decreases robustness and increase likelihood of inaccuracy of such measurements. The rate of data loss, as mentioned above, is also increased. This is primarily because of the increased rate of handovers and ping-pongs, but also because LTM (at L1/L2) requires HARQ reset and the absence of RLC ARQ for RLC unacknowledged mode (UM).

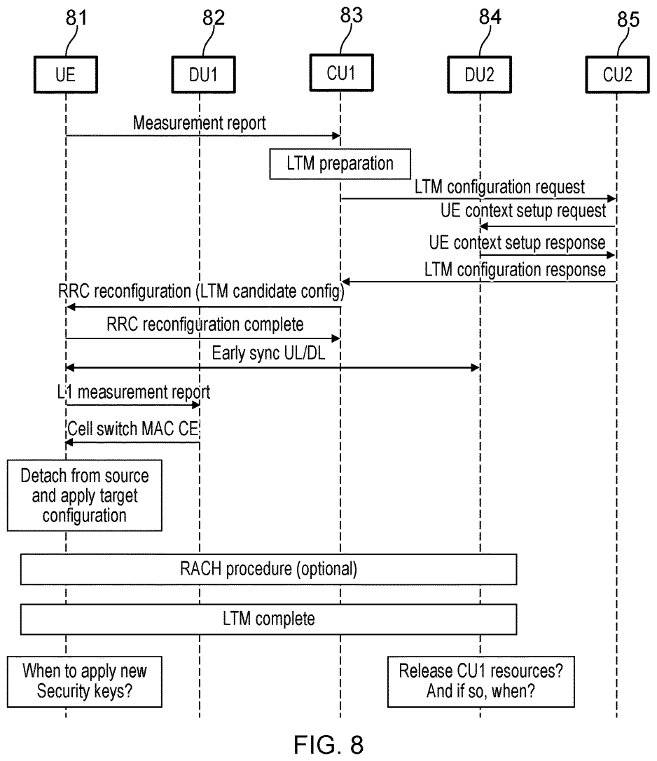

As noted above, inter-CU LTM is not yet specified in the 3GPP standards at the priority date of the present disclosure. FIG. 8 shows an example expected message sequence for inter-CU LTM, where a UE 81 is handed over from a source CU 83 (and its associated DU 82) to a target CU 85 (and its associated DU 84). The example expected message sequence shown in FIG. 8 for inter-CU LTM is broadly comparable to the proposed message sequence for intra-CU LTM as shown in FIG. 7. Some further messages exchanged between the target CU 85 and both the target DU 84 and source CU 83 are also shown, between the LTM preparation step and RRC reconfiguration message transmission step, but otherwise, the operations are similar to those described above with respect to FIG. 7.

However, there are some open issues arising from this example expected message sequence for inter-CU LTM. One of these is when should the target cell security key be applied, and how? Security key change requires PDCP re-establishment, resulting in data loss as any data maintained at the PDCP is deleted. Because there is likely to be a greater number of handovers using LTM instead of procedures involving higher layers, as well as the likely increased number of ping-pong handovers between source and target cells, as observed in Rel-18, such PDCP re-establishment (as well as RLC and MAC reset or re-establishment) would be required much more frequently, meaning more frequent data loss. The number of ping-pong handovers is not affected by whether the source and target cells are controlled by different CUs or the same CU, but is instead based on radio conditions, as they are generally based on one-shot measurements as described above. As noted above, security key changes will require PDCP/RLC/MAC reset/re-establishment in addition to the signalling of the new keys themselves, and so in addition to the higher data loss rate issue noted above, this will introduce latencies to the procedure, potentially making LTM performance similar to or worse than that of current L3 handover procedures. Therefore, changing security keys every time when such LTM handover takes place (where there is the possibility of a ping-pong handover following it) will result in both a higher data loss (due to PDCP re-establishments and hence loss of data maintained on PDCP) and higher latencies. Another open issue arising from the example expected message sequence for inter-CU LTM as shown in FIG. 8 is when should the target CU (i.e. CU2 85) release the resources of the source CU (i.e. CU1 83)? Generally, for higher layer handover procedures, this is done upon completion of the handover. However, with the increased likelihood of ping-pong handovers in LTM, and the issue of data loss associated with them, this may not be the most efficient or effective time to release such resources.

Embodiments of the present disclosure seek to provide solutions to such problems.

### Inter-CU LTM and CU-DU Interface Impacts

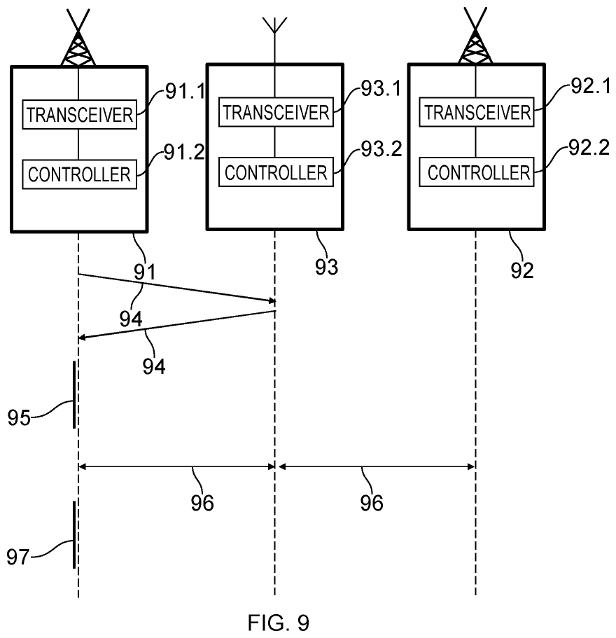

FIG. 9 shows a part schematic, part message flow diagram representation of a first wireless communications system comprising a source central unit (CU) 91, a target central unit (CU) 92, and a communications device 93 (e.g., a UE 14) in accordance with at least some embodiments of the present technique. The communications device 93 and the source and target CUs are configured to transmit signals to and/or receive signals from each other via respective source and target distributed units (DUs) which are not shown in FIG. 9. The source CU 91, target CU 92, and communications device 93 each comprise a transceiver (or transceiver circuitry) 91.1, 92.1, 93.1, and a controller (or controller circuitry) 91.2, 92.2, 93.2. Each of the controllers 91.2, 92.2, 93.2 may be, for example, a microprocessor, a CPU, or a dedicated chipset, etc.

As shown in the example of FIG. 9, the transceiver circuitry 91.1 and the controller circuitry 91.2 of the source CU 91 are configured in combination to transmit 94 signals to and/or receiving signals from the communications device 93 which is operating in a connected state with the source CU 91, to determine 95 that the communications device 93 is to hand over from the source CU 91 to the target CU 92, to perform 96, with the communications device 93 and the target CU 92, a handover procedure to hand the communications device 93 over from the source CU 91 to the target CU 92, wherein the handover procedure consists of signalling only at a physical layer at each of the source CU 91, the target CU 92, and the communications device 93 and/or a data link layer at each of the source CU 91, the target CU 92, and the communications device 93, and to control 97, for a specified time period following the handover procedure, a target distributed unit, DU, associated with the target CU 92.

Essentially, such embodiments of the present technique as exemplified by FIG. 9 propose that, even after a UE has been handed over (via an LTM handover) to a target CU (and its associated target DU), the source CU maintains at least some level of control over that target DU for a period of time after the LTM handover is complete. This allows for the issues described above related to the increased rate of ping-pongs, as handing back over to the source CU following such a ping-pong is quicker and easier, and the increased rate of data loss, as such data may be maintained through the control of the target DU by the source CU resulting in a PDCP re-establishment procedure not having to take place straight away after handover, instead waiting until a time at which the UE's connection to the target CU is stable and the likelihood of a ping-pong handover has reduced.

One such manifestation of the source CU's control over the target DU is through the use of security keys, and when they are changed with respect to the handover procedure. As those skilled in the art would be aware, new security keys (for communication with the target CU) could be applied by the UE:
Before the UE sends an LTM complete message;
Upon the UE determining completion of the LTM procedure based on RACH;
Upon reception of a (first) PDCCH from the target cell; or
At the time of transmission over configured grant resources, where such transmission takes place with new security keys.

Each of these possibilities have already been discussed with respect to the LTM completion procedure. For the inter-CU scenario with which arrangements of embodiments of the present technique are concerned, security keys are also changed during this LTM completion procedure. This is aligned to legacy handover handling, whereby new keys are applied before the RRCReconfigurationComplete message is sent to the target gNB so that this message is encrypted using target cell keys. However, the drawback of each of these possibilities is that any ping-pong handovers will increase data interruption, since PDCP re-establishment will take place and security keys will again need to be changed upon the ping-pong handover taking place.

Recognising this, arrangements of embodiments of the present technique propose that new security keys are not applied for the first handover (or a number of already known handovers) between cells controlled by different CUs within a certain geographical region. In other words, during the handover procedure, the source CU may be configured to determine that a current security key used by the communications device for communication with the source CU will not be changed upon completion of the handover procedure (and therefore, after handover-at least for a specified period of time-the communications device will continue to use the current security key for communication with the target DU). The current F1 interface allows a DU to be connected to a single CU, but also allows implemented-based solutions where a single DU can be connected to more than one CU. Such solutions may be applied to address the above-identified technical problems.

In some arrangements of embodiments of the present technique, the source CU (also referred to herein as CU1) may decide that security keys shall not be changed and may indicate this intention to the target CU (also referred to herein as CU2) while sending the LTM configuration indicating that a new key is not required (or at least, not immediately upon completion of the LTM handover procedure). In other words, during the handover procedure, the source CU may be configured to transmit to the target CU, an indication that the current security key will not be changed upon completion of the handover procedure. CU1 may send an RRCReconfiguration message to the UE indicating that a new key derivation is not required. In other words, during the handover procedure, the source CU may be configured to transmit to the communications device, an indication that the communications device is not to derive a new security key to replace to the current security key upon completion of the handover procedure.

Here, changes are required in respect of which CU (i.e. CU1 or CU2) will provide the UE context setup request message to the target DU (also referred to herein as DU2) in order to set up resources for the UE during the LTM handover procedure. Here, either CUI will require a direct connection with DU2, or DU2 configuration will need to follow the traditional route that CU2 initiates the UE context setup signalling to DU2. If CUI initiate the signalling, then the outcome of admission control for admitting this UE shall be shared with CU2. If signalling comes from CU2 then admission control is carried out during this procedure itself. However, here, in accordance with such arrangements of embodiments of the present technique, CU2 is to indicate, in the UE Context Setup Request message, that an F1-U (GTP tunnel) link is set up between CU1 and DU2 for carrying RRC messages and UE user data. In other words, the step of controlling the target DU for the specified time period may comprise setting up a wireless (i.e. radio) or wired communication link between the source CU and the target DU. The source CU may be configured to transmit, to the target DU via the wireless or wired communication link for forwarding to the communications device during the specified time period, downlink data and/or radio resource control, RRC, signalling messages, and/or to receive, from the target DU via the communication link during the specified time period, uplink data and/or RRC signalling messages transmitted to the target DU by the communications device. Here, the UE context relating signalling sent by CU2 to DU2 (based on the LTM configuration received from CU1) may configure CU1-DU2 with the GTP tunnel configured to carry RRC signalling and user plane data between the UE and CU1. In other words, the target CU may be configured to transmit, to the target DU, a signalling message indicating that the source CU is to control the target DU for the specified time period by setting up a communication link between the source CU and the target DU. Such arrangements of embodiments of the present technique are explained in greater detail below.

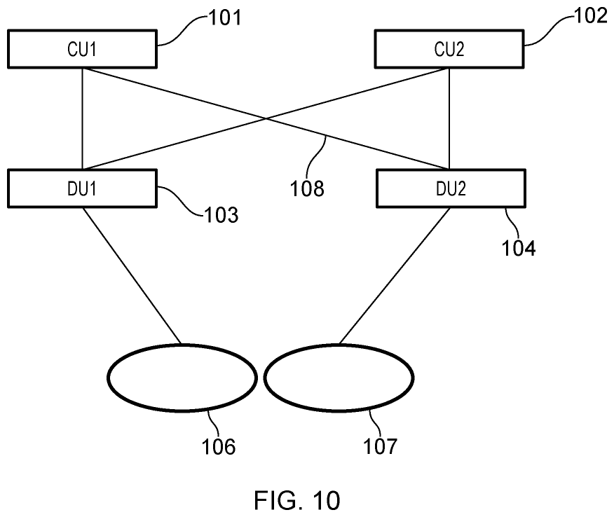

Data communicated between the UE and DU2 following handover will thus be ciphered and/or deciphered using the existing CUI keys, and this traffic will either be communicated via CU2 or may be communicated directly between CU1 and DU2. The existing GTP-U tunnel establishment procedure is already flexible enough to provide end points (i.e. two way exchange where each side provides its own end point), while IP routing can be used if traffic goes via CU2. Here, the difficulty will be with respect to RRC signalling termination and encryption/integrity protection of RRC signalling, because CU2 should not handle signalling encrypted/protected by using CU1 keys. RRC signalling is not transported using any tunnel mechanism, and so it cannot be routed via CU2. Hence, one option anticipated by arrangements of embodiments of the present technique is that DU2 connects to CUI as well as CU2, as described above, and as shown in FIG. 10 below.

As shown in FIG. 10, DU2 104 may be connected (via the newly set up GTP tunnel) to CU1 101, in addition to connecting to CU2 102, and may send/receive data traffic directly to CU1 101. At the same time, RRC signalling from UE and received via DU2 104 may also be terminated at CU1 101. In other words, there is an F1-U path 108 set up between DU2 104 and CU1 101 for this UE. FIG. 10 also shows an F1-U path between CU2 102 and DU1 103—this is to demonstrate that a path corresponding to F1-U path 108 could be set up for UEs which are handed over in the opposite direction. As those skilled in the art would appreciate, this architecture is similar to mesh networks for user plane path. CU1 101 and CU2 102 here may exchange signalling indicating their (and indeed DU2's 104) respective capabilities to support the additional GTP-U tunnel 108 between DU2 104 and CU1 101. In other words, the source CU may be configured to receive, from the target CU, an indication that the target DU is capable of being controlled by the source CU during the specified time period, and/or to transmit, to the target CU, an indication that the source CU is capable of controlling the target DU during the specified time period.

After subsequent handovers within CU2, there will (for security reasons as well as efficiency of communications) eventually be a need to change security keys derived for CU2. In other words, inter-CU security key change may take place during either a subsequent intra-CU LTM handover or as a standalone procedure. In order to achieve this, CUI derives the new security key (i.e. KgNB*) while providing the LTM configuration and an indication (which may be an implicit indication or an explicit indication) that CU2 can use the new security key for a later handover or at a later stage. To do so, CUI should already be aware that CU2 has the capability to use this security key at a later stage, and continue with the current (i.e. CU1) security key for the time being. In other words, the source CU may be configured to transmit, to the target CU, an indication of a new security key to be used by the communications device for communication with the target CU, wherein the indication of the new security key comprises an indication that the new security key should replace a current security key being used by the communications device for communication with the source CU based on a predetermined condition being met (and therefore, after handover—until this predetermined condition is met—the communications device will continue to use the current security key for communication with the target DU). The procedure for security key change then used may be a known procedure, but the trigger for the change in security keys is new. Likewise, until this predetermined condition is met, the F1-U path between CU1 and D2 may be maintained.

Here, this predetermined condition may—as noted above—be that a subsequent handover (e.g. an inter-DU, intra-DU, or intra-CU) handover of the communications device takes place. In other words, the predetermined condition may be that the target CU is performing a second handover procedure with the communications device to hand the communications device over either from the target CU to a new target CU or from a first cell to a second cell, wherein both the first cell and the second cell are controlled by the target CU. Alternatively, the predetermined condition may be that a specified time period (e.g. a time of stay (TOS) of the communications device with the target CU) may have elapsed. If UE stays beyond this TOS and is not handed over back to CU1 (i.e. due to a ping-pong handover), CU2 may initiate the security key update procedure and also instruct CU1 to release resources and context associated with the UE. Alternatively, the predetermined condition may be that the CU2 decides itself to use the keys later or to perform the key change procedure at a time that it best sees fit. Here, CU2 should inform CU1 that it is going to (or has) changed to using the new security key (e.g. during LTM configuration procedure) so that CU1 is prepared to receive security protected data/signalling from DU2. In other words, the predetermined condition may be that the target CU determines, independently of the source CU, that the new security key should replace the current security key. Here, the source CU may be configured to receive, from the target CU, an indication of when the new security key will replace the target security key.

Typically, UE resources and context at CU1 will be released immediately at the end of the handover procedure shown by FIG. 8. However, in order to solve the above-described problem of data loss during ping-pong handovers (e.g. due to PDCP re-establishment), it may be required that CU1 resources are not released immediately on the network side because traffic may still terminate in CU1 (and not get to CU2). CU2 may be required to delete CU1 resources by explicitly sending the UE context release message over the X2/Xn interface, but this message is sent later—after HO execution is completed—and when it is known or at least reasonable likely that there will be no ping-pong or that the old security keys are not used forever. In other words, the source CU may be configured to maintain, after the handover procedure has been completed, context information associated with the communications device, to receive, from the target CU at a time (which may be a time later than the end of the handover procedure itself) after the handover procedure has been completed and when at least one predetermined condition has been met, an indication that the source CU should release the context information associated with the communications device, and to release the context information associated with the communications device. Here, CU2 may decide to release resources at CU1 by sending an indication over the X2 interface to CU1, and at the same time, initiate the security key change procedure with the UE so that the UE starts using security keys derived for CU2. Again here, the indication that the source CU should release the context information associated with the communications device may be received from the target CU after the specified time period has elapsed (i.e. the predetermined condition may be that the specified time period, which may be the TOS of the UE in the new cell, has passed). Alternatively, or in addition, the indication that the source CU should release the context information associated with the communications device may be received from the target CU after the communications device and the target CU have begun communicating using a new security key instead of a current security key that was used by the communications device for communication with the source CU (i.e. the predetermined condition may be that a security key change has taken place). The predetermined condition may alternatively or additionally comprise the radio conditions between the UE and CU2 becoming stable, or a GTP tunnel set up between DU2 and CU1 (as shown in the example of FIG. 10) having been closed, and hence no traffic between DU2 and the UE now terminates in CU1.

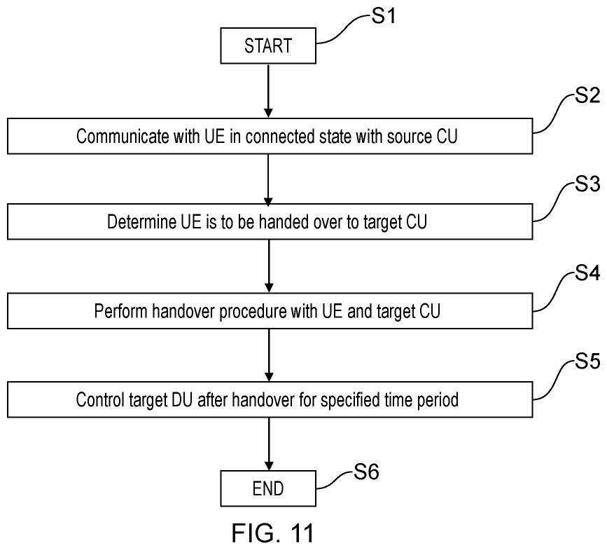

FIG. 11 shows a flow diagram illustrating a first example process of communications in a communications system in accordance with embodiments of the present technique. The process shown by FIG. 11 is specifically a method of operating a source central unit, CU, of a wireless communications network.

The method begins in step S1. The method comprises, in step S2, transmitting signals to and/or receiving signals from a communications device (e.g. UE) which is operating in a connected state with the source CU. In step S3, the process comprises determining that the communications device is to hand over from the source CU to a target CU of the wireless communications network. Then, in step S4, the method comprises performing, with the communications device and the target CU, a handover procedure to hand the communications device over from the source CU to the target CU, wherein the handover procedure consists of signalling only at a physical layer at each of the source CU, the target CU, and the communications device and/or a data link layer at each of the source CU, the target CU, and the communications device. In step S5, the method comprises controlling, for a specified time period following the handover procedure, a target distributed unit, DU, associated with the target CU. The process ends in step S6.

Those skilled in the art would appreciate that the method shown by FIG. 11 may be adapted in accordance with embodiments of the present technique. For example, other intermediate steps may be included in such a method, or the steps may be performed in any logical order. Though embodiments of the present technique have been described largely by way of the example communications system shown in FIG. 9, it would be clear to those skilled in the art that they could be equally applied to other systems to those described herein.

Those skilled in the art would further appreciate that such infrastructure equipment and/or communications devices as herein defined may be further defined in accordance with the various arrangements and embodiments discussed in the preceding paragraphs. It would be further appreciated by those skilled in the art that such infrastructure equipment and communications devices as herein defined and described may form part of communications systems other than those defined by the present disclosure.

The following numbered paragraphs provide further example aspects and features of the present technique:

Paragraph 1. A method of operating a source central unit, CU, of a wireless communications network, the method comprising
transmitting signals to and/or receiving signals from a communications device which is operating in a connected state with the source CU,
determining that the communications device is to hand over from the source CU to a target CU of the wireless communications network,
performing, with the communications device and the target CU, a handover procedure to hand the communications device over from the source CU to the target CU, wherein the handover procedure consists of signalling only at a physical layer at each of the source CU, the target CU, and the communications device and/or a data link layer at each of the source CU, the target CU, and the communications device, and
controlling, for a specified time period following the handover procedure, a target distributed unit, DU, associated with the target CU.

Paragraph 2. A method according to Paragraph 1, wherein the step of controlling the target DU for the specified time period comprises setting up a communication link between the source CU and the target DU.

Paragraph 3. A method according to Paragraph 2, comprising
transmitting, to the target DU via the communication link for forwarding to the communications device during the specified time period, downlink data and/or radio resource control, RRC, signalling messages, and/or
receiving, from the target DU via the communication link during the specified time period, uplink data and/or RRC signalling messages transmitted to the target DU by the communications device.

Paragraph 4. A method according to any of Paragraphs 1 to 3, wherein, during the handover procedure, the method comprises
determining that a current security key used by the communications device for communication with the source CU will not be changed upon completion of the handover procedure.

Paragraph 5. A method according to Paragraph 4, wherein, during the handover procedure, the method comprises
transmitting, to the target CU, an indication that the current security key will not be changed upon completion of the handover procedure.

Paragraph 6. A method according to Paragraph 4 or Paragraph 5, wherein, during the handover procedure, the method comprises
transmitting, to the communications device, an indication that the communications device is not to derive a new security key to replace to the current security key upon completion of the handover procedure.

Paragraph 7. A method according to any of Paragraphs 1 to 6, comprising
receiving, from the target CU, an indication that the target DU is capable of being controlled by the source CU during the specified time period.

Paragraph 8. A method according to any of Paragraphs 1 to 7, comprising
transmitting, to the target CU, an indication that the source CU is capable of controlling the target DU during the specified time period.

Paragraph 9. A method according to any of Paragraphs 1 to 8, comprising
transmitting, to the target CU, an indication of a new security key to be used by the communications device for communication with the target CU,
wherein the indication of the new security key comprises an indication that the new security key should replace a current security key being used by the communications device for communication with the source CU based on a predetermined condition being met.

Paragraph 10. A method according to Paragraph 9, wherein the predetermined condition is that the target CU is performing a second handover procedure with the communications device to hand the communications device over either from the target CU to a new target CU or from a first cell to a second cell, wherein both the first cell and the second cell are controlled by the target CU.

Paragraph 11. A method according to Paragraph 9 or Paragraph 10, wherein the predetermined condition is that the specified time period has elapsed.

Paragraph 12. A method according to any of Paragraphs 9 to 11, wherein the predetermined condition is that the target CU determines, independently of the source CU, that the new security key should replace the current security key.

Paragraph 13. A method according to Paragraph 12, comprising
receiving, from the target CU, an indication of when the new security key will replace the target security key.

Paragraph 14. A method according to any of Paragraphs 1 to 13, comprising
maintaining, after the handover procedure has been completed, context information associated with the communications device,
receiving, from the target CU at a time after the handover procedure has been completed and when at least one predetermined condition has been met, an indication that the source CU should release the context information associated with the communications device, and
releasing the context information associated with the communications device.

Paragraph 15. A method according to Paragraph 14, wherein the at least one predetermined condition being met comprises the specified time period having elapsed.

Paragraph 16. A method according to Paragraph 14 or Paragraph 15, wherein the at least one predetermined condition being met comprises the communications device and the target CU having begun communicating using a new security key instead of a current security key that was used by the communications device for communication with the source CU.

Paragraph 17. A source central unit, CU, of a wireless communications network, the source CU comprising
transceiver circuitry configured to transmit signals to and/or to receive signals, and
controller circuitry configured in combination with the transceiver circuitry
to transmit signals to and/or receiving signals from a communications device which is operating in a connected state with the source CU,
to determine that the communications device is to hand over from the source CU to a target CU of the wireless communications network,
to perform, with the communications device and the target CU, a handover procedure to hand the communications device over from the source CU to the target CU, wherein the handover procedure consists of signalling only at a physical layer at each of the source CU, the target CU, and the communications device and/or a data link layer at each of the source CU, the target CU, and the communications device, and
to control, for a specified time period following the handover procedure, a target distributed unit, DU, associated with the target CU.

Paragraph 18. Circuitry for a source central unit, CU, of a wireless communications network, the circuitry comprising
transceiver circuitry configured to transmit signals to and/or to receive signals, and
controller circuitry configured in combination with the transceiver circuitry
to transmit signals to and/or receiving signals from a communications device which is operating in a connected state with the source CU,
to determine that the communications device is to hand over from the source CU to a target CU of the wireless communications network,
to perform, with the communications device and the target CU, a handover procedure to hand the communications device over from the source CU to the target CU, wherein the handover procedure consists of signalling only at a physical layer at each of the source CU, the target CU, and the communications device and/or a data link layer at each of the source CU, the target CU, and the communications device, and
to control, for a specified time period following the handover procedure, a target distributed unit, DU, associated with the target CU.

Paragraph 19. A method of operating a target central unit, CU, of a wireless communications network, the method comprising
determining that a communications device is to hand over from a source CU of the wireless communications network to the target CU,
performing, with the communications device and the source CU, a handover procedure to hand the communications device over from the source CU to the target CU, wherein the handover procedure consists of signalling only at a physical layer at each of the source CU, the target CU, and the communications device and/or a data link layer at each of the source CU, the target CU, and the communications device, and
determining that, for a specified time period following the handover procedure, a target distributed unit, DU, associated with the target CU will be controlled by the source CU.

Paragraph 20. A method according to Paragraph 19, comprising
transmitting, to the target DU, a signalling message indicating that the source CU is to control the target DU for the specified time period by setting up a communication link between the source CU and the target DU.

Paragraph 21. A method according to Paragraph 19 or Paragraph 20, wherein, during the handover procedure, the method comprises
receiving, from the source CU, an indication that a current security key used by the communications device for communication with the source CU will not be changed upon completion of the handover procedure.

Paragraph 22. A method according to any of Paragraphs 19 to 21, comprising
transmitting, to the source CU, an indication that the target DU is capable of being controlled by the source CU during the specified time period.

Paragraph 23. A method according to any of Paragraphs 19 to 22, comprising
receiving, from the source CU, an indication that the source CU is capable of controlling the target DU during the specified time period.

Paragraph 24. A method according to any of Paragraphs 19 to 23, comprising
receiving, from the source CU, an indication of a new security key to be used by the communications device for communication with the target CU,
wherein the indication of the new security key comprises an indication that the new security key should replace a current security key being used by the communications device for communication with the source CU based on a predetermined condition being met.

Paragraph 25. A method according to Paragraph 24, wherein the predetermined condition is that the target CU is performing a second handover procedure with the communications device to hand the communications device over either from the target CU to a new target CU or from a first cell to a second cell, wherein both the first cell and the second cell are controlled by the target CU.

Paragraph 26. A method according to Paragraph 24 or Paragraph 25, wherein the predetermined condition is that the specified time period has elapsed.

Paragraph 27. A method according to any of Paragraphs 24 to 26, wherein the predetermined condition is that the target CU determines, independently of the source CU, that the new security key should replace the current security key.

Paragraph 28. A method according to Paragraph 27, comprising
transmitting, to the source CU, an indication of when the new security key will replace the target security key.

Paragraph 29. A method according to any of Paragraphs 19 to 28, comprising
transmitting, to the source CU at a time after the handover procedure has been completed and when at least one predetermined condition has been met, an indication that the source CU should release context information associated with the communications device.

Paragraph 30. A method according to Paragraph 29, wherein the at least one predetermined condition being met comprises the specified time period having elapsed.

Paragraph 31. A method according to Paragraph 29 or Paragraph 30, wherein the at least one predetermined condition being met comprises the communications device and the target CU having begun communicating using a new security key instead of a current security key that was used by the communications device for communication with the source CU.

Paragraph 32. A target central unit, CU, of a wireless communications network, the target CU comprising
transceiver circuitry configured to transmit signals to and/or to receive signals, and
controller circuitry configured in combination with the transceiver circuitry
to determine that a communications device is to hand over from a source CU of the wireless communications network to the target CU,
to perform, with the communications device and the source CU, a handover procedure to hand the communications device over from the source CU to the target CU, wherein the handover procedure consists of signalling only at a physical layer at each of the source CU, the target CU, and the communications device and/or a data link layer at each of the source CU, the target CU, and the communications device, and
to determine that, for a specified time period following the handover procedure, a target distributed unit, DU, associated with the target CU will be controlled by the source CU.

Paragraph 33. Circuitry for a target central unit, CU, of a wireless communications network, the circuitry comprising
transceiver circuitry configured to transmit signals to and/or to receive signals, and
controller circuitry configured in combination with the transceiver circuitry
to determine that a communications device is to hand over from a source CU of the wireless communications network to the target CU,
to perform, with the communications device and the source CU, a handover procedure to hand the communications device over from the source CU to the target CU, wherein the handover procedure consists of signalling only at a physical layer at each of the source CU, the target CU, and the communications device and/or a data link layer at each of the source CU, the target CU, and the communications device, and
to determine that, for a specified time period following the handover procedure, a target distributed unit, DU, associated with the target CU will be controlled by the source CU.

Paragraph 34. A wireless communications system comprising a source central unit, CU, according to Paragraph 17 and a target CU according to Paragraph 32.

Paragraph 35. A computer program comprising instructions which, when loaded onto a computer, cause the computer to perform a method according to any of Paragraphs 1 to 16 or Paragraphs 19 to 31.

Paragraph 36. A non-transitory computer-readable storage medium storing a computer program according to Paragraph 35.

It will be appreciated that the above description for clarity has described embodiments with reference to different functional units, circuitry and/or processors. However, it will be apparent that any suitable distribution of functionality between different functional units, circuitry and/or processors may be used without detracting from the embodiments.

Described embodiments may be implemented in any suitable form including hardware, software, firmware or any combination of these. Described embodiments may optionally be implemented at least partly as computer software running on one or more data processors and/or digital signal processors. The elements and components of any embodiment may be physically, functionally and logically implemented in any suitable way. Indeed, the functionality may be implemented in a single unit, in a plurality of units or as part of other functional units. As such, the disclosed embodiments may be implemented in a single unit or may be physically and functionally distributed between different units, circuitry and/or processors.

Although the present disclosure has been described in connection with some embodiments, it is not intended to be limited to the specific form set forth herein. Additionally, although a feature may appear to be described in connection with particular embodiments, one skilled in the art would recognise that various features of the described embodiments may be combined in any manner suitable to implement the technique.

### REFERENCES

[1] Holma H. and Toskala A, “LTE for UMTS OFDMA and SC-FDMA based radio access”, John Wiley and Sons, 2009.
[2] TS 38.470, “3rd Generation Partnership Project; Technical Specification Group Radio Access Network; NG-RAN; F1 general aspects and principles (Release 17)”, 3GPP, V17.4.0, March 2023.
[3] TS 38.473, “3rd Generation Partnership Project; Technical Specification Group Radio Access Network; NG-RAN; F1 application protocol (F1AP) (Release 17)”, 3GPP, V17.4.1, April 2023.
[4] TS 38.401, “3rd Generation Partnership Project; Technical Specification Group Radio Access Network; NG-RAN; Architecture description (Release 17)”, 3GPP, V17.4.0, March 2023.
[5] TS 38 472, “3rd Generation Partnership Project; Technical Specification Group Radio Access Network; NG-RAN; F1 signalling transport (Release 15)”, 3GPP, V15.2.0, September 2018.
[6] TS 38.300, “3rd Generation Partnership Project; Technical Specification Group Radio Access Network; NR; NR and NG-RAN Overall Description; Stage 2 (Release 17)”, 3GPP, V17.4.0, March 2023.
[7] TS 23.501, “3rd Generation Partnership Project; Technical Specification Group Services and System Aspects; System architecture for the 5G System (5GS); Stage 2 (Release 18)”, 3GPP, V18.2.0, June 2023.
[8] TS 36.300, “3rd Generation Partnership Project; Technical Specification Group Radio Access Network; Evolved Universal Terrestrial Radio Access (E-UTRA) and Evolved Universal Terrestrial Radio Access Network (E-UTRAN); Overall description; Stage 2 (Release 17)”, 3GPP, V17.4.0, March 2023.
[9] R2-2305305, “Change Request for 38.300 running CR for introduction of NR further mobility enhancements”, MediaTek Inc., vivo, 3GPP TSG-RAN WG2 Meeting #122, May 2023.
[10] R2-2305305, “Data Loss at LTM Cell Switch”, MediaTek Inc., 3GPP TSG-RAN WG2 Meeting #122, May 2023.

1. A method of operating a source central unit, CU, of a wireless communications network, the method comprising
transmitting signals to and/or receiving signals from a communications device which is operating in a connected state with the source CU,
determining that the communications device is to hand over from the source CU to a target CU of the wireless communications network,
performing, with the communications device and the target CU, a handover procedure to hand the communications device over from the source CU to the target CU, wherein the handover procedure consists of signalling only at a physical layer at each of the source CU, the target CU, and the communications device and/or a data link layer at each of the source CU, the target CU, and the communications device, and
controlling, for a specified time period following the handover procedure, a target distributed unit, DU, associated with the target CU.

2. A method according to claim 1, wherein the step of controlling the target DU for the specified time period comprises setting up a communication link between the source CU and the target DU.

3. A method according to claim 2, comprising
transmitting, to the target DU via the communication link for forwarding to the communications device during the specified time period, downlink data and/or radio resource control, RRC, signalling messages, and/or
receiving, from the target DU via the communication link during the specified time period, uplink data and/or RRC signalling messages transmitted to the target DU by the communications device.

4. A method according to claim 1, wherein, during the handover procedure, the method comprises
determining that a current security key used by the communications device for communication with the source CU will not be changed upon completion of the handover procedure.

5. A method according to claim 4, wherein, during the handover procedure, the method comprises
transmitting, to the target CU, an indication that the current security key will not be changed upon completion of the handover procedure.

6. A method according to claim 4, wherein, during the handover procedure, the method comprises
transmitting, to the communications device, an indication that the communications device is not to derive a new security key to replace to the current security key upon completion of the handover procedure.

7. A method according to claim 1, comprising
receiving, from the target CU, an indication that the target DU is capable of being controlled by the source CU during the specified time period.

8. A method according to claim 1, comprising
transmitting, to the target CU, an indication that the source CU is capable of controlling the target DU during the specified time period.

9. A method according to claim 1, comprising
transmitting, to the target CU, an indication of a new security key to be used by the communications device for communication with the target CU,
wherein the indication of the new security key comprises an indication that the new security key should replace a current security key being used by the communications device for communication with the source CU based on a predetermined condition being met.

10. A method according to claim 9, wherein the predetermined condition is that the target CU is performing a second handover procedure with the communications device to hand the communications device over either from the target CU to a new target CU or from a first cell to a second cell, wherein both the first cell and the second cell are controlled by the target CU.

11. A method according to claim 9, wherein the predetermined condition is that the specified time period has elapsed.

12. A method according to claim 9, wherein the predetermined condition is that the target CU determines, independently of the source CU, that the new security key should replace the current security key.

13. A method according to claim 12, comprising
receiving, from the target CU, an indication of when the new security key will replace the target security key.

14. A method according to claim 1, comprising
maintaining, after the handover procedure has been completed, context information associated with the communications device,
receiving, from the target CU at a time after the handover procedure has been completed and when at least one predetermined condition has been met, an indication that the source CU should release the context information associated with the communications device, and
releasing the context information associated with the communications device.

15. A method according to claim 14, wherein the at least one predetermined condition being met comprises the specified time period having elapsed.

16. A method according to claim 14, wherein the at least one predetermined condition being met comprises the communications device and the target CU having begun communicating using a new security key instead of a current security key that was used by the communications device for communication with the source CU.

17. A source central unit, CU, of a wireless communications network, the source CU comprising
transceiver circuitry configured to transmit signals to and/or to receive signals, and
controller circuitry configured in combination with the transceiver circuitry
to transmit signals to and/or receiving signals from a communications device which is operating in a connected state with the source CU,
to determine that the communications device is to hand over from the source CU to a target CU of the wireless communications network,
to perform, with the communications device and the target CU, a handover procedure to hand the communications device over from the source CU to the target CU, wherein the handover procedure consists of signalling only at a physical layer at each of the source CU, the target CU, and the communications device and/or a data link layer at each of the source CU, the target CU, and the communications device, and
to control, for a specified time period following the handover procedure, a target distributed unit, DU, associated with the target CU.

18.-31. (canceled)

32. A target central unit, CU, of a wireless communications network, the target CU comprising
transceiver circuitry configured to transmit signals to and/or to receive signals, and
controller circuitry configured in combination with the transceiver circuitry
to determine that a communications device is to hand over from a source CU of the wireless communications network to the target CU,
to perform, with the communications device and the source CU, a handover procedure to hand the communications device over from the source CU to the target CU, wherein the handover procedure consists of signalling only at a physical layer at each of the source CU, the target CU, and the communications device and/or a data link layer at each of the source CU, the target CU, and the communications device, and
to determine that, for a specified time period following the handover procedure, a target distributed unit, DU, associated with the target CU will be controlled by the source CU.

33.-36. (canceled)
